(19) United States
(12) Patent Application Publication
(10) Pub. No.: US 2009/0099977 A1
(43) Pub. Date: Apr. 16, 2009

(54) Annuity Contract Management System and Method Thereof

(76) Inventors: Yung-Sung Chien, Taipei City (TW); Frank Kuen-Bao Ling, Kaohsiung County (TW)

Correspondence Address: NORTH AMERICA INTELLECTUAL PROPERTY CORPORATION, P.O. BOX 506, MERRIFIELD, VA, 22116, US

(21) Appl. No.: 12/250,544

(22) Filed: Oct. 14, 2008

(30) Foreign Application Priority Data
Oct. 16, 2007 (TW) 096138630
Aug. 22, 2008 (TW) 097132007

(51) Int. Cl. G06Q 40/00

(52) U.S. Cl. 705/36 R

(57) ABSTRACT

Method performed by an annuity contract system includes managing a bid module according to participation of a user; before the user starts to pay premiums according to an annuity contract, generating a premium amount through the bid module and a investment management module; and at an end of premium terms as specified in the annuity contract, determining an annuity amount according to a remaining asset of the user settled according to the annuity contract, a result of managing the bid module, and a management result of the investment management module.

### BACKGROUND OF THE INVENTION

1. Field of the Invention

The present invention relates to annuity contract e-commerce; and more particularly, an annuity contract management system and method thereof.

2. Description of the Prior Art

Though annuity is a type of insurance, it is different from life insurance. The purpose of life insurance is to protect an insured individual's family upon the potential early death of the insured individual. However, the annuity is to protect an insured individual upon his loss of income due to his potential longevity. That is, the life insurance is to make ready the death of the insured individual; the annuity is to make ready the retirement of the insured individual. After paying a series of premiums, an insured individual of life insurance receives a promise of receiving a sum of money upon the occurrence of the insured individual's death or other event. However, an insured individual of annuity receives a promise of receiving a sum of money periodically while the insured individual is still alive. That is, the insured individual can receive annuities only when he is still alive.

In recent years, due to rising life expectancy and declining fertility, population aging has become a highly generalized process. According to a study conducted in Japan in 1997, the senior population ratio was 14.5% in 1995, but is expected to rise to 27.4% and 32.2% in 2025 and 2050 respectively. On the other hand, the life employment system of the industrial era is not as common, and salary is not likely to increase with the years of work experience. Therefore, a personal retirement plan has become essential and annuity has become an important financial product.

Annuity has been in Japan for more than 40 years. According to the “Basic Life Survey,” more than 50% income of senior families comes from public annuity. More than 45% senior families live only by annuity. Contrarily, annuity income replacement rate is less than 25%. This number means that annuity has tremendous potential of growing in Taiwan. However, except for national pension and enterprise annuity, commercial annuity is still under-developed.

After many years of studying, the inventor of the present invention believes that annuity in Japan was emerged during the industrial era when labors were employed for their lifetime. Commercial annuity sprouted as it was propelled by national pension and enterprise annuity. During the developing phase of 1970's and 1980's, Taiwan's economy was mainly driven by medium and small manufacturing businesses. Their minimal profit margin was unable to provide employees any pension. However, the current information technology age provides a great amount of information and dynamic financial products; thus annuities calculated based on 2% interest rate for 2-year-term-deposit generated from regular fixed deposits cannot satisfy aggressive investors. It is therefore important to create an annuity platform which can satisfy investors capable of taking different degrees of risks.

U.S. Pat. No. 6,611,815, “Method and System for Providing Account in an Annuity with Life Contingencies,” provides an annuity product which provides a death benefit or cash surrender benefit while issuing annuities. Compared to other annuity products which only issue annuities, the annuity product of U.S. Pat. No. 6,611,815 accumulates the account value for an applicant, thus the beneficiary can receive a death benefit or cash surrender benefit in addition to annuities. Though the account value is eventually reimbursed to the applicant, the account value is incremented in the traditional manner. Further, the applicant may need to sacrifice certain annuities to accumulate the benefit, so it is basically similar to the traditional annuity products.

U.S. Pat. No. 7,080,032, “Annuity Having Interest Rate Coupled to a Referenced Interest Rate,” refers to an annuity which provides upward adjustments to the interest rate if there is a corresponding increase in a specified referenced rate. If the referenced rate has decreased, the interest rate that will be credited to the annuity account value will be the guaranteed base interest rate. After five years, annuities will start to be issued. The guaranteed base interest rate is set to prevent downward adjustments of the interest rate due to the overall economy. If the specified referenced rate is too high, the return of the annuity would not have a strong growth potential. If the specified referenced rate is too low, the company handling the annuity has to take enormous interest rate risk. Thus, the patent fails to provide an optimized solution for the purchaser and company.

US patent application publication No. 2005/0187840, “System and Process for Providing Multiple Income Start Dates for Annuities,” divides the premiums deposited by the annuity applicant into a plurality of portion segments. The portion segments are included in a single contract and are operated separately, and the consignee has the flexibility to make deposits and receive annuities. The patent application also diversifies the financial risk of the annuity applicant. However, there is nothing special about the connections of different portion segments. And purchasing a plurality of annuity products may cause additional management hassle to the annuity applicant.

### SUMMARY OF THE INVENTION

It is therefore a purpose of the present invention to provide an annuity contract system and method performed by the annuity contract system to solve the problems of the prior art so as to expand the credit of the consignee and earn greater investment return for the consignee.

An embodiment of the present invention provides a method performed by an annuity contract system. The method comprises managing a bid module according to participation of a user; before the user starts to pay premiums according to an annuity contract, generating a premium amount through the bid module and an investment management module; and at an end of premium terms as specified in the annuity contract, determining an annuity amount according to a remaining asset of the user settled according to the annuity contract, a result of managing the bid module, and a management result of the investment management module.

Another embodiment of the present invention provides an annuity contract management system. The system comprises a bid module for managing a bid module according to participation of a user; a cash flow process module for processing an insurance premium of an annuity insurance contract, a trust fund of an annuity trust contract, a bid placed in the bid module which has not won the bid, an amount of bid won by the applicant, a reimbursement which the bid winner makes, an annuity generated by settling a remaining asset of the user according to an annuity contract, and a result of managing the bid module at an end of premium terms as specified in the annuity contract; and an annuity calculation module for determining an annuity amount according to the remaining asset of the user and the annuity contract.

Another embodiment of the present invention provides a method performed by an annuity contract system. The method comprises managing a bid module according to participation of a user; before the user starts to pay premiums according to an annuity contract, generating a premium amount through the bid module and an investment management module; and if the user rescinds the annuity contract before an end of premium terms as specified in the annuity contract, settling a remaining asset of the user according to a result of managing the bid module, and a management result of the investment management module.

Another embodiment of the present invention provides an annuity contract management system. The system comprises a bid module for managing a bid module according to participation of a user; and a cash flow process module for settling a remaining asset of the user according to a result of managing the bid module if the user rescinds an annuity contract before an end of premium terms as specified in the annuity contract.

In summary, the present invention creates an annuity contract system and method performed by the annuity contract system to solve the problems of the prior art. The present invention has the following advantages:

(1) The present invention provides a bid module. Through placing a bid, the consignee can switch payments from fixed interest-rate premium payments to variable premium payments.

(2) The bid module can react to the market condition. When economy is picking up, various financial products can be invested and interest rate will move upward. When economy is slowing down, fewer financial products can be invested and interest rate will go down. Thus interest rate will be reflected in the bid module. The annuity contract becomes a direct-finance annuity product.

(3) The annuity contract of the present invention can maintain the principle and accrued interest. It can provide positive return and possible high investment return.

(4) The annuity system is operated by the user. The system is only responsible to provide investment products and asset allocation options. Thus the user can determine which risk he will take.

(5) The annuity contract of the present invention can provide life annuity, minimum guaranteed annuity and short term annuity options, etc.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a method performed by an annuity contract system according to the present invention.

FIG. 2 is an analysis diagram of placing a bid and issuance of an annuity according to the present invention.

FIG. 3 is an annuity contract system of the annuity contract according to the present invention.

### DETAILED DESCRIPTION

Embodiments of the present invention are described in detail as follows:

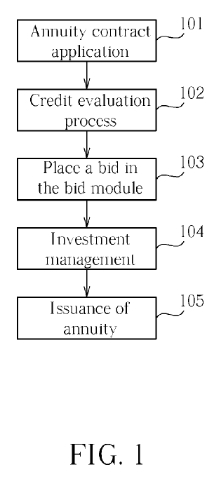

FIG. 1 is a flowchart of a method performed by an annuity contract system according to the present invention. As shown in FIG. 1, in Step 101, a user enters an annuity contract system through a user interface to apply for an annuity contract. The annuity contract is combined with a bid module to perform premium and annuity operations. Initially the user applies for a one-year electronic annuity contract certificate, and the system receives the one-year electronic annuity contract certificate application. Then a network authentication organization reviews the electronic annuity contract certificate application to verify the identity of the user so as to generate an authentication result. After the authentication result is generated, the user uses the electronic annuity contract certificate to make an on-line application and chooses which type of annuity contract to set up, e.g. annuity insurance contract, annuity trust contract, or other financial annuity contracts. Thus, after the system receives an annuity contract application and basic information of the user, the system underwrites the annuity contract according to the authentication result and the annuity contract application so as to generate an electronic contract to the user. The system checks the identity of the user and the annuity contract application, such as visible and hidden risk factors. The system also evaluates and determines the conditions for establishing the contract and the coverage scope of the annuity. If the user applies for an annuity insurance contract, it is underwritten as an insurance contract. If the user applies for an annuity trust contract, it is underwritten as a trust contract. Then the system sends a contract establishment message to the user and generates an electronic contract. After generating the electronic contract, the system sends the electronic contract to an external agency for verification. The external agency then returns a verification result to the system. Finally the system sends the verification result to the user via a server. If the user wants to place a bid in the bid module, then in Step 102, the system will perform a credit evaluation process to grant the user a credit amount for placing a bid in the bid module. The sum of the credit amount and an accumulated amount of deposits is an amount the user is able to place the bid and a total amount of deposits the user has to make after winning the bid. Based on the personal credit of the user, the system can grant the user a credit amount to place the bid in the bid module. Further a credit amount may be granted by performing a guarantee process, performing a credit check process or checking credit of a guarantor. Then the system can review, assess and manage collateral or the guarantor provided by the user. Yet the credit evaluation process demands the sum of the credit amount and the accumulated amount of deposits to be no less than a required minimum bid for placing the bid in the bid module. On the contrary, if the user chooses not to place a bid and simply makes deposits, the credit evaluation process does not need to be performed. Thus after performing the credit evaluation process, in Step 103, the user can place a bid in the bid module if he wants to do so. In Step 104, if the user has placed a bid and won the bid, an amount which the user has won will be transferred to ajoint account of the investment management module. Further, the system will calculate and update the asset value of the user's investment periodically. When annuities are to be issued, an amount will be generated through the bid module and the investment management module so as to issue annuities. Thus at the end of premium terms as specified in the annuity contract, settle the user's remaining annuity asset according to an annuity issue date specified in the annuity contract, the result of placing a bid in the bid module, and the management result of the investment management module such as investment performance or accrued interest so as to determine the amount of annuities. Further in Step 105, issue the annuities periodically according to the annuity contract to the applicant of the annuity contract.

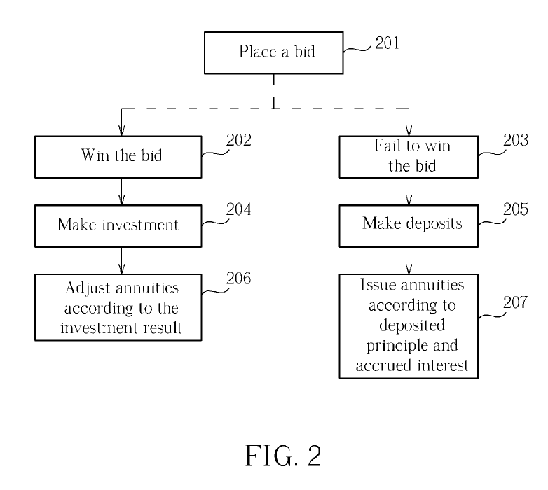

FIG. 2 is an analysis diagram of placing a bid and issuance of an annuity according to the present invention. In Step 201, after assessing the credit of the user, the user can place a bid in the bid module. The bidding duration of the bid module is linked to the premium terms of the contract. Moreover, the overall period which the user can place a bid is equal to the overall premium payment duration. Thus in Step 202, when the user wins a bid, in Step 204, the system will transfer the amount which the user has won to an investment management module for fund management. Therefore, when the user wins the bid, the amount which the user has won will be transferred to a personal account, and the system will transfer the amount which the user has won to ajoint account of the investment management module for making investment. However, in Step 206, if the user has won the bid before or at an end of a bidding term as specified in the annuity contract, the system will settle the personal account, and determine the annuity amount according to an account balance of the personal account and the annuity contract. Finally the system will issue annuities to the user according to the conditions specified in the annuity contract. On the contrary, if the user does not want to place a bid and just wants to make deposits, or if the user fails to win a bid during the bidding term, then in Step 205, the user simply makes deposits. In other words, after the user participates in the bid module and fails to win a bid, savings are deposited to a personal account of the user according to the result of the bid module. Thus if the user fails to win a bid before the end of a bidding term specified in the annuity contract, settle the personal account and determine the annuity amount according to the balance of the personal account and the annuity contract such as the first date for issuing annuities. The balance of the personal account comprises the principle deposited and interest accrued during the bidding term. If the user does not place a bid in the bid module, savings are deposited to a personal account of the user according to the result of the bid module. Thus at the end of the premium terms specified in the annuity contract, settle the personal account and determine the annuity amount according to the balance of the personal account and the annuity contract such as the first date for issuing annuities. The balance of the personal account comprises the principle deposited and interest accrued during the bidding term. Finally in Step 207, the system issues annuities to the user, the applicant of the annuity contract, periodically. The total amount of annuities to be issued equals to the annuities specified in the contract and interest accrued from the paid premiums. Please note, the annuity contract can be an annuity insurance contract, annuity trust contract, or another financial annuity contract. If the user applies for an annuity insurance contract, after paying all premiums the user starts to receive annuities till his death. If the user rescinds the contract in case he dies before the end of premium terms, then no annuity is to be issued. If the user applies for the annuity trust contract, after paying all premiums the user starts to receive annuities till the expiration time specified in the annuity trust contract. If the user rescinds the contract in case he dies before the end of premium terms, then no annuity is to be issued, and settle the personal account and reimburse the balance to the user, the applicant of the annuity trust contract, if the user did not place any bid or did not win any bid. If the user has won a bid, settle the personal account by deducting the amount owing from the investment return.

Please note, the premiums paid during the premium terms as specified in the annuity contract include premiums for insurance or trust and amounts dedicated to the bid module. The amounts dedicated to the bid module are for reimbursement if the user has won the bid, or for making deposits if the user has not won the bid or has not placed a bid.

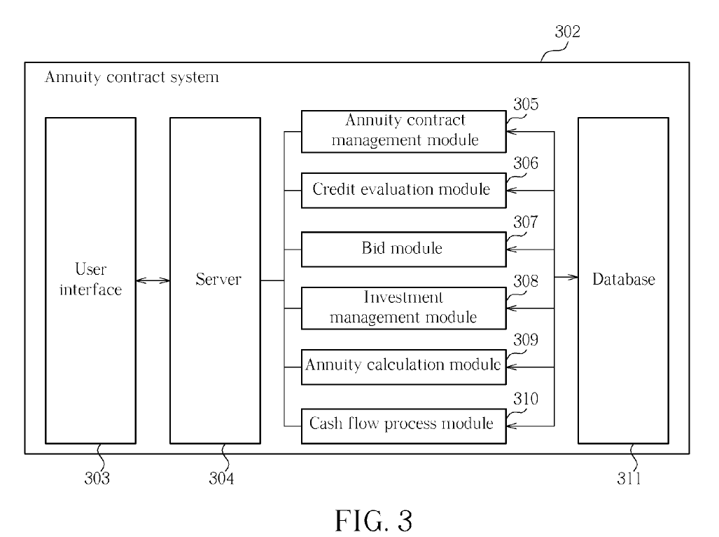

Please refer to FIG.3. FIG. 3 is an annuity contract system 302 of the annuity contract according to the present invention. As shown in FIG. 3, the annuity contract system 302 comprises a server 304. Through a wired or wireless network, a user links a user interface 303 and the server 304 via a computer, cellular phone or PDA. Thus the server 304 can exchange information with an applicant/user via a communications network, wired communications device or wireless communications device. Further, the server 304 links various modules with a database 311 to store data, information and results to respective portions of the database 311. The annuity contract system 302 comprises the following modules:

An annuity contract process module 305 coupled to the server 304 for receiving an electronic annuity contract certificate application of the user. The user can use the electronic annuity contract certificate to purchase an annuity contract on line. Thus after the annuity contract process module 305 receives an annuity contract application and basic information of the user, the annuity contract process module 305 reviews the identity of the user, the applicant of the annuity contract, and the annuity contract application according to the electronic annuity contract certificate of the user, such as visual and hidden risk factors of the applicant of the annuity contract. Through the operation, process, analysis, comparison or execution of the server 304, the annuity contract system 302 evaluates and determines the conditions for establishing the contract and the coverage scope of the annuity. Thus the annuity contract system 302 sends a contract establishment message to the user. After collecting required fees, the annuity contract system 302 produces an electronic contract. After verification of the electronic contract, the annuity contract system 302 transmits a verification result to the user through the server 304. Moreover, the annuity contract process module 305 stores the electronic contract in the database 311;

A credit evaluation module 306 coupled to the server 304 for calculating a bid amount required for placing a bid, evaluating collateral or a guarantee amount needs to be provided by the user, and assessing the value of the collateral or a guarantor provided by the user. Through the operation, process, analysis, comparison or execution of the server 304, the credit evaluation module 306 transmits the result to the user and stores the result in the database 311;

A bid module 307 coupled to the server 304 for providing the bid module to the user to place a bid. Through the operation, process, analysis, comparison or execution of the server 304, and bids placed by bidders, the bid module 307 selects at least one bidder as the bid winner. Further the bid module 307 sends the bid result to the server 304 and discloses the bid result via the user interface 303. Then deposits of a user who has lost the bid or who has not placed the bid are deposited to a personal account in the bid module 307. In additional to receive deposits, the personal account is for future reimbursements of the user if he wins a bid in the future. If a user is the bid winner, the annuity contract system 302 will store the amount which the user has won to his personal account, and then transfer the amount to ajoint account of the following investment management module 308 and store the result in the database 311;

An investment management module 308 coupled to the server 304 for receiving the amount which the user has won, and transfer the amount to an investment asset for making investments. Through the operation, process, analysis, comparison or execution of the server 304, the investment management module 308 transmits the updates of the asset to the server 304, stores the updates in the database 311, and discloses the asset through the user interface 303;

An annuity calculation module 309 coupled to the server 304 for tracking annuity issue dates as specified in the annuity contract. At the start of the annuity issue dates, the annuity calculation module 309 calculates the asset of the applicant of the annuity contract according to the performance of his investment if he has won a bid or according to the principle and accrued interest of the applicant if he has not won any bid. Through the operation, process, analysis, comparison or execution of the server 304, the annuity calculation module 309 issues annuities periodically according to conditions specified in the annuity contract and stores the result in the database 311;

A cash flow process module 310 coupled to the server 304 for processing the cash flow related to the annuity contract, such as an insurance premium of an annuity insurance contract, a trust fund of an annuity trust contract, a bid placed in the bid module which has not won the bid, an amount of bid won by the applicant, a reimbursement which the bid winner makes, etc. Through the operation, process, analysis, comparison or execution of the server 304, the cash flow process module 310 stores the result in the database 311.

A plurality of examples are described below to illustrate the embodiments of the present invention:

### EXAMPLE I

Jan. 10, 2007 was Ming's 40^{th} birthday. He had some savings and would like to purchase an annuity insurance contract as a source of stable income after his retirement. Thus he bought a new investment insurance contract from XX insurance company which has variable premiums and fixed annuities. The conditions of the new investment insurance contract are as follows:

Whole Life Annuity Contract

Annuity Conditions:
Applicant: Ming
Premium duration: 20 years (monthly payments)
Premium amount: variable according to the bid module
1^{st} annuity issue date: 2027/10/01
Annuity amount: NT$10,000/month, adjustable according to
investment performance
Conditions for Placing a Bid:
Bid duration: 20 years, once a month
Upper bid limit: NT$10,000
Lower bid limit: calculated according to the floating rate of the 1-year
term deposit of the Post Office, currently at 2.48%
Others:
1. allow the insurer to evaluate the credit of the applicant
2. the applicant is allowed to invest in various financial products of
the insurer

Under the conditions, Ming has to deposit the amount of the difference between the upper bid limit and the lower bid limit. For instance, if the lower bid limit of the first bid is NT$500, then Ming has to deposit NT$9,500. And this deposit will become NT$10,000 after Ming wins the bid or after 20 years. If Ming does not place any bid in the 20-year bid duration, then the deposits made during the 20-year bid duration would become NT$2,400,000 on Jan. 10, 202. And Ming can receive NT$10,000 every month until his death.

If Ming believes that economy is picking up on Jan. 9, 2012 after he has paid 59 premiums, thus he decides to place a bid to expand his potential return on investment. Ming mortgages his house to place a bid of NT$1000 in the sixtieth term and wins the bid, then Min can receive a total amount of NT$2,210,000 (NT$10,000×59+NT$9,000×180). Then XX insurance company can use the total amount to make investment for Ming. In the next 180 terms, Ming has to reimburse the mortgaged amount of NT$10,000 each term.

Suppose after investing the total bid amount for 15 years (180 terms), and the annualized return is 5%, then the accumulated amount will become 4,594,431, which is 2,194,431 more than if Ming does not place any bid in the 20-year bid duration. Then the accumulated amount will be converted into annuities much higher than NT$10,000/month as specified in the annuity contract.

### EXAMPLE II

In this example, Ming chose to purchase an annuity trust contract from XX bank which has variable premiums and has a fixed term. The conditions of the annuity trust contract are as follows:

Fixed Term Annuity Trust Contract

Annuity Conditions:
Consigner: Ming
Premium duration: 20 years (monthly payments)
Premium amount: variable according to the bid module
1^{st} annuity issue date: 2027/10/01
Annuity amount: NT$10,000/month, adjustable according to
investment performance, and 3% additional annual return from the 1^{st}
annuity issue date
Last annuity issue date: 2047/10/01
Conditions for Placing a Bid:
Bid duration: 20 years, once a month
Upper bid limit: NT$10,000
Lower bid limit: calculated according to the floating rate of the 1-year
term deposit of the Post Office, currently at 2.48%
Others:
1. allow the consignee to evaluate the credit of the consigner
2. consigner is allowed to invest in various financial products of
the consignee

Under the conditions, if Ming does not place a bid and make deposits instead, then after all the premiums are paid, Ming will receive annuities each of NT$16,000 which include NT$10,000 as specified in the trust contract and 3% additional annual return of NT$6,000 (NT$2,400,000×3%/12). However, since the trust contract is a fixed term contract, the contract is terminated after NT$2,400,000 is completely issued. That is, annuities will be issued until Ming is 80 years old.

If Ming places a bid and receives a total bid amount of NT$4,594,431 after all premiums are paid, then over the 20 years which Ming can receive annuities, Ming can receive NT$30,629 per month which includes NT$19,143 (NT$4,594,431/240) and additional return of NT$11,486 (NT$4,594,431×3%/12), thus will greatly enhance the financial security of Ming after he is retired.

Those skilled in the art will readily observe that numerous modifications and alterations of the device and method may be made while retaining the teachings of the invention.

What is claimed is:

1. A method performed by an annuity contract system comprising:
managing a bid module according to participation of a user;
before the user starts to pay premiums according to an annuity contract, generating a premium amount through the bid module and an investment management module; and
at an end of premium terms as specified in the annuity contract, determining an annuity amount according to a remaining asset of the user settled according to the annuity contract, a result of managing the bid module, and a management result of the investment management module.

2. The method of claim 1 further comprising:
receiving an electronic annuity contract certificate application of the user;
verifying the electronic annuity contract certificate application through a network authentication organization to verify an identification of the user so as to generate an authentication result;
receiving an annuity contract application; and
underwriting the annuity contract according to the authentication result and the annuity contract application so as to generate an electronic contract to the user.

3. The method of claim 1 further comprising:
performing a credit evaluation process to grant the user a credit amount to place a bid in the bid module;
wherein a sum of the credit amount and an accumulated amount of deposits is an amount the user is able to place the bid and a total amount of deposits the user has to make after winning the bid.

4. The method of claim 3 wherein performing the credit evaluation process comprises:
performing a guarantee process to grant the user a credit amount to place the bid in the bid module.

5. The method of claim 3 wherein performing the credit evaluation process comprises:
performing a credit check process to grant the user a credit amount to place the bid in the bid module.

6. The method of claim 3 wherein performing the credit evaluation process comprises:
checking credit of a guarantor to grant the user a credit amount to place the bid in the bid module.

7. The method of claim 3 wherein performing the credit evaluation process comprises demanding the sum of the credit amount and the accumulated amount of deposits to be no less than a required minimum bid for placing the bid in the bid module.

8. The method of claim 1 wherein managing the bid module according to the participation of the user comprises if the user has placed a bid and won the bid, transferring an amount which the user has won to the investment management module.

9. The method of claim 1 wherein:
managing the bid module according to the participation of the user comprises if the user has placed the bid and has not won the bid, making a deposit to a personal account of the user according to a result of placing the bid in the bid module; and
determining the annuity amount according to the remaining asset of the user settled according to the annuity contract, and the result of managing the bid module comprises if the user has not won the bid before an end of a bidding term as specified in the annuity contract, calculating an account balance of the personal account, and determining the annuity amount according to the account balance and the annuity contract.

10. The method of claim 1 wherein:
managing the bid module according to the participation of the user comprises if the user has placed the bid and has won the bid, depositing an amount which the user has won to a personal account of the user according to a result of placing the bid in the bid module and the management result of the investment management module; and
determining the annuity amount according to the remaining asset of the user settled according to the annuity contract, the result of managing the bid module, and the management result of the investment management module comprises if the user has won the bid before or at an end of a bidding term as specified in the annuity contract, settling the personal account, and determining the annuity amount according to an account balance of the personal account and the annuity contract.

11. The method of claim 1 wherein:
managing the bid module according to the participation of the user comprises if the user has not placed the bid in the bid module, making a deposit to a personal account of the user according to a result of not placing the bid in the bid module and the management result of the investment management module; and
determining the annuity amount according to the remaining asset of the user settled according to the annuity contract, the result of managing the bid module, and the management result of the investment management module comprises at the end of premium terms as specified in the annuity contract, settling the personal account, and determining the annuity amount according to an account balance of the personal account and the annuity contract.

12. An annuity contract management system comprising:
a bid module for managing a bid module according to participation of a user;
a cash flow process module for settling a remaining asset of the user according to an annuity contract, and a result of managing the bid module at an end of premium terms as specified in the annuity contract; and
an annuity calculation module for determining an annuity amount according to the remaining asset of the user.

13. A method performed by an annuity contract system comprising:
managing a bid module according to participation of a user;
before the user starts to pay premiums according to an annuity contract, generating a premium amount through the bid module and an investment management module; and
if the user rescinds the annuity contract before an end of premium terms as specified in the annuity contract, settling a remaining asset of the user according to a result of managing the bid module, and a management result of the investment management module.

14. The method of claim 1 3 further comprising:
receiving an electronic annuity contract certificate application of the user;
verifying the electronic annuity contract certificate application through a network authentication organization to verify an identification of the user so as to generate an authentication result;
receiving an annuity contract application; and
underwriting the annuity contract according to the authentication result and the annuity contract application so as to generate an electronic contract to the user.

15. The method of claim 13 further comprising:
performing a credit evaluation process to grant the user a credit amount to place a bid in the bid module.

16. The method of claim 15 wherein performing the credit evaluation process comprises:
performing a guarantee process to grant the user a credit amount to place the bid in the bid module.

17. The method of claim 15 wherein performing the credit evaluation process comprises:
performing a credit check process to grant the user a credit amount to place the bid in the bid module.

18. The method of claim 15 wherein performing the credit evaluation process comprises:
checking credit of a guarantor to grant the user a credit amount to place the bid in the bid module.

19. The method of claim 15 wherein performing the credit evaluation process comprises demanding the credit amount of the user to be no less than a required minimum bid for placing the bid in the bid module.

20. The method of claim 13 wherein managing the bid module according to the participation of the user comprises if the user has placed a bid and won the bid, transferring an amount which the user has won to the investment management module.

21. The method of claim 13 wherein:
managing the bid module according to the participation of the user comprises if the user has placed the bid and has not won the bid, making a deposit to a personal account of the user according to a result of placing the bid in the bid module; and
settling the remaining asset of the user according to the result of managing the bid module comprises if the user has not won the bid before an end of a bidding term as specified in the annuity contract, settling the personal account.

22. The method of claim 13 wherein:
managing the bid module according to the participation of the user comprises if the user has placed the bid and has won the bid, depositing an amount which the user has won to a personal account of the user according to a result of placing the bid in the bid module and the management result of the investment management module; and
settling the remaining asset of the user according to the result of managing the bid module, and the management result of the investment management module comprises if the user has won the bid before an end of a bidding term as specified in the annuity contract, settling the personal account and paying off an unsettled balance of remaining premium terms as specified in the annuity contract.

23. The method of claim 13 wherein:
managing the bid module according to the participation of the user comprises if the user has not placed the bid in the bid module, making a deposit to a personal account of the user according to a result of not placing the bid in the bid module; and
settling the remaining asset of the user according to the result of managing the bid module comprises if the user rescinds the annuity contract before the end of premium terms as specified in the annuity contract, settling the personal account.

24. An annuity contract management system comprising:
a bid module for managing a bid module according to participation of a user; and
a cash flow process module for settling a remaining asset of the user according to a result of managing the bid module if the user rescinds an annuity contract before an end of premium terms as specified in the annuity contract.
